(19) United States
(12) Patent Application Publication
(10) Pub. No.: US 2022/0142405 A1
(43) Pub. Date: May 12, 2022

(54) PELLET FEEDER SHUT-OFF MECHANISM FOR PELLET GRILLS AND SMOKERS

(71) Applicant: W.C. BRADLEY CO., Columbus, GA (US)

(72) Inventors: Thomas Kessler, Columbus, GA (US); RAMIN KHOSRAVI RAHMANI, Columbus, GA (US); ANTHONY HAMILTON, Hamilton, GA (US)

(21) Appl. No.: 17/523,872

(22) Filed: Nov. 10, 2021

Related U.S. Application Data
(60) Provisional application No. 63/112,024, filed on Nov. 10, 2020.

(51) Int. Cl. A47J 37/07; F24B 13/04; F24B 1/10

(52) U.S. Cl. CPC A47J 37/0704; F24B 1/10; F24B 13/04

(57) ABSTRACT

A pellet fuel delivery channel spans between a pellet fuel hopper and a firepot. A door selectively blocks fuel pellets from leaving the hopper and entering the fuel delivery channel.

### CROSS-REFERENCE TO RELATED CASES

This application claims the benefit of U.S. provisional patent application Ser. No. 63/112,024, filed on Nov. 10, 2020, and incorporates such provisional application by reference into this disclosure as if fully set out at this point.

### FIELD OF THE INVENTION

This disclosure relates to outdoor cooking devices in general and, more specifically, to an enhanced pellet feeding mechanism for a pellet fueled grill.

### BACKGROUND OF THE INVENTION

In a pellet smoker or grill, a wood pellets stored in a hopper travel through a delivery channel into a firepot to be smoldered or burned for smoking or grilling. The delivery channel can use augers, conveyer belts, pistons, chutes and such to transport the wood pellets from the hopper into the firepot. For the wood pellets used for cooking, the pelletizing process may use biomass (such as sawdust) in the feedstock without any external binders (additives). Instead, the natural hemi-cellulous acts as a binder. Natural bonding between the wood particles occurs due to the adhesive products produced by degradation of hemi-cellulose.

The hemi-cellulose used in manufacturing of the wood pellets used for cooking applications has a random and amorphous structure with little strength, and can be easily hydrolyzed. Therefore, pellets manufactured using this process have very low resistance against moisture. This is mainly because the degraded hemi-cellulose can lose its binding strength when in contact with water or in a humid environment.

Pellets inside the hopper and/or the delivery channel that are slightly exposed to limited moisture from the surrounding environment degenerate as they absorb the moisture and, in turn, swell. Difficulties may be encountered transporting the swelled pellets into the firepot. Further, humid pellets cannot properly ignite. Additional exposure to moisture can easily turn the pellets into a sawdust paste that is highly viscous and amplifies the transportation complications. Such paste may not smolder or combust at all. If the sawdust paste remains in the system it may mold. Additionally, the compromised pellets or sawdust paste drying inside the delivery channel around the transportation device (such as the auger) can lead to a complete jamming of the whole pellet handling and delivery system. The obstructed pellet delivery system makes the smoker/grill entirely dysfunctional.

What is needed is a system and method for dealing with the above, and related, issues.

### SUMMARY OF THE INVENTION

The invention of the present disclosure, in one aspect thereof, comprises a system including a pellet fuel delivery channel spanning between a pellet fuel hopper and a firepot, and a door selectively blocking fuel pellets from leaving the hopper and entering the fuel delivery channel.

In some embodiments, the fuel delivery channel is defined by an auger tube and the door comprises a sleeve defining a cutout that is rotatable about the auger tube to selectively cover an opening defined in the tube. The sleeve may be rotatable about the auger tube by an electric motor.

In some embodiments, the fuel delivery channel is defined by an auger tube having an opening into the delivery channel, and the door slides axially along the auger tube to open and close the opening into the delivery channel. The door may comprise a sleeve surrounding the auger tube. The door may be moved axially along the auger tube via an electric motor engaging with a pinion and a rack on a lower side of the sleeve. In other embodiments, the door comprises an arcuate member atop the auger tube. The arcuate member may be moved axially along the auger tube by an electric motor engaged with a pinion and a rack on the arcuate member. In further embodiments, the door comprises a flat panel opening and closing a lower opening of the hopper. The flat panel may be moved to open and close the hopper by an electric motor engaged with a pinion and a rack on the flat panel.

The invention of the present disclosure, in another aspect thereof, comprises a system having a cooking chamber with a cooking grate, a firepot utilizing pelletized fuel to heat the cooking chamber, a cabinet outside the cooking chamber having a hopper for receiving the pelletized fuel, a delivery channel moving pelletized fuel from the hopper to the firepot, and a pellet fuel shutoff door selectively blocking pelletized fuel from entering into the delivery channel from the fuel hopper.

The delivery channel may be defined by an auger tube having an opening that receives pelletized fuel from the fuel hopper when the shutoff door is in an open position. In some embodiments, the pellet fuel cutoff door further comprises a sleeve coaxial with the auger tube and defining a cutout, the sleeve being rotatable such that the cutout aligns with the opening in the auger tube to admit pelletized fuel from the hopper, and being further rotatable such that the cutout does not align with the opening in the auger tube and pelletized fuel from the hopper is blocked.

In other embodiments, the pellet fuel cutoff door further comprises an arcuate member fitted to the auger tube and slidable axially along the tube to selectively cover the opening in the auger tube. In further embodiments, the pellet fuel shutoff door comprises a flat panel below the hopper. The shutoff door may have a pinion affixed thereto, the shutoff door being moved between a closed position and the open position by a pinion meshed with the rack and driven by an electric motor.

The invention of the present disclosure, in another aspect thereof, comprises a method including providing a firepot that burns pelletized fuel in a cooking chamber for cooking food on a cooking grate within the cooking chamber, providing a fuel hopper outside the cooking chamber, providing a fuel delivery channel between the fuel hopper and the cooking chamber, and providing a door that selectively blocks fuel from the hopper from entering the fuel delivery channel.

The method may include providing a fuel delivery channel further comprising placing an auger tube between the fuel hopper and the firepot, and providing a door further comprises placing a sleeve on the auger tube that may be moved to cover an opening defined in the tube. In other embodiments, the method includes providing a fuel delivery channel further comprising placing an auger tube between the fuel hopper and the firepot, and providing a door further comprises placing a sleeve on the auger tube that has a cutout that may be moved to align or misalign with an opening defined in the tube.

The method may also include providing an electric motor configured to move the door between open and closed positions to selectively block fuel from the hopper from entering the fuel delivery channel.

### BRIEF DESCRIPTION OF THE DRAWINGS

FIG. 1A is a perspective view of a pellet feed shutoff mechanism according to the present disclosure.

FIG. 1B is another perspective view of a pellet feed shutoff mechanism according to the present disclosure.

FIG. 2 is a perspective view of the pellet feed shutoff mechanism of FIGS. 1A-1B in the context of a hopper and pellet delivery system.

FIG. 3A is a perspective cutaway view of a pellet feed shutoff mechanism according to aspects of the present disclosure in an open state.

FIG. 3B is a perspective cutaway view of the pellet feed shutoff mechanism of FIG. 3A approximately half closed.

FIG. 3C is a perspective cutaway view of the pellet feed shutoff mechanism of FIG. 3A nearly completely closed.

FIG. 3D is a perspective cutaway view of the pellet feed shutoff mechanism of FIG. 3A completely closed.

FIG. 4A is an overhead simplified view of a pellet feed shutoff mechanism according to the present disclosure in an open state.

FIG. 4B is a side view of the pellet feed shutoff mechanism of FIG. 4A.

FIG. 4C is an overhead simplified view of the pellet feed shutoff mechanism of FIG. 4B in a closed state.

FIG. 4D is a side view of the pellet feed shutoff mechanism of FIG. 4C.

FIG. 5A is a simplified side view of a pellet feed shutoff mechanism according to the present disclosure.

FIG. 5B is a simplified side cutaway view o the pellet feed shutoff mechanism of FIG. 5A.

FIG. 6A is a simplified inferior view of the pellet feed shutoff mechanism of FIG. 5A in an open position in the context of a hopper and pellet delivery system.

FIG. 6B is a side view of the pellet feed shutoff mechanism of FIG. 6A.

FIG. 6C is an inferior view of the pellet feed shutoff mechanism of FIG. 6A in a closed position.

FIG. 6D is a side view of the pellet feed shutoff mechanism of FIG. 6C.

FIG. 7A is a simplified perspective view of another pellet feed shutoff mechanism of the present disclosure in the context of a hopper and pellet delivery system.

FIG. 7B is a side view of the pellet feed shutoff mechanism of FIG. 7A in an open position.

FIG. 7C is a side view of the pellet feed shutoff mechanism of FIG. 7A in a closed position.

FIG. 8A is a simplified perspective view of another pellet feed shutoff mechanism of the present disclosure in the context of a hopper and pellet delivery system.

FIG. 8B is a side view of the pellet feed shutoff mechanism of FIG. 8A in an open position.

FIG. 8C is a side view of the pellet feed shutoff mechanism of FIG. 8A in a closed position.

FIG. 9 is a frontal cutaway view of a pellet grill having a pellet feed shutoff mechanism according to the present disclosure.

### DETAILED DESCRIPTION OF THE PREFERRED EMBODIMENTS

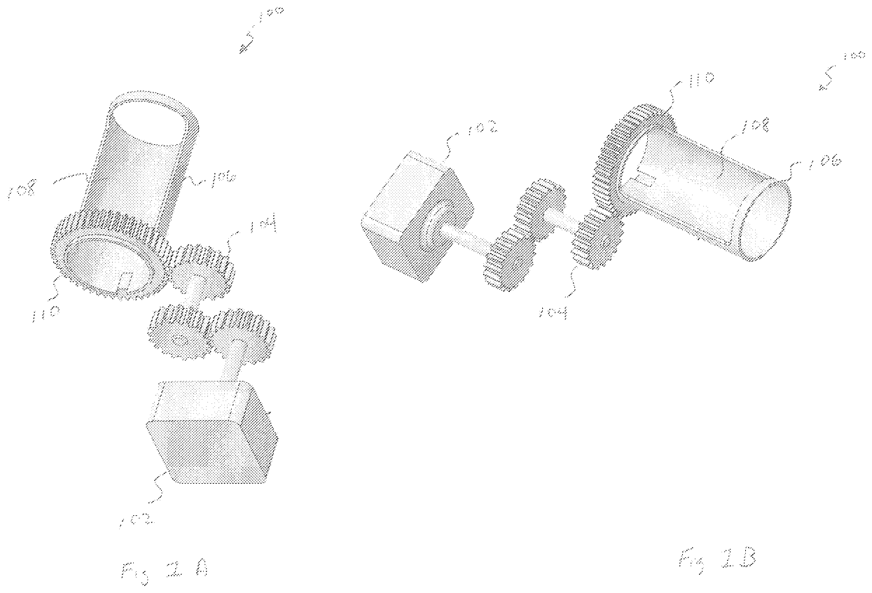

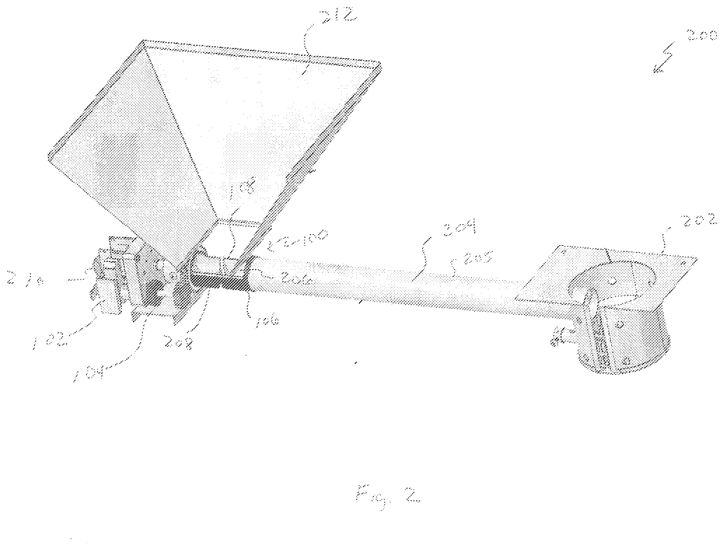

Referring now to FIG. 1A is a perspective view of a pellet feed shutoff mechanism 100 according to the present disclosure is shown. FIG. 1B is another perspective view of the pellet feed shutoff mechanism 100. FIG. 2 is a perspective view of the pellet feed shutoff mechanism 100 in the context of a hopper and pellet delivery system 200. A motor 102 may have an output shaft connecting to a rotary sleeve 106 or other door or blocking panel. A gear system 104 may be provided (and may provide reduction gearing as needed) for communicating power from the motor 102 to the sleeve 106. The sleeve 106 may be generally in the form of a hollow cylinder with a cutout 108 defined therein. A gear ring 110 may be providing or affixed to the sleeve 106 for meshing the sleeve 106 to gear system 104 or directly to the motor 102 or its output shaft. The sleeve 106 may also be turned manually, by an external knob on the gear system 104, for example.

As best seen in FIG. 2, a portion of a pellet fueled grill 200 is shown for context for the system 100. A firepot 202 may provide combustion and heat as is known in the art. A delivery channel 204 may be defined by an auger tube 205 with an opening 206 defined in a position where fuel pellets may flow the tube 204 from a pellet hopper 212. An auger 208 may rotate within the tube 204 powered by a motor 210 for moving the pellets in the tube 204 to the firepot 202. The sleeve 106 may be located in a position on the tube 204 so as to selectively open or close the opening 206 by movement of the opening 108 in the sleeve 106 to coincide with the opening 206.

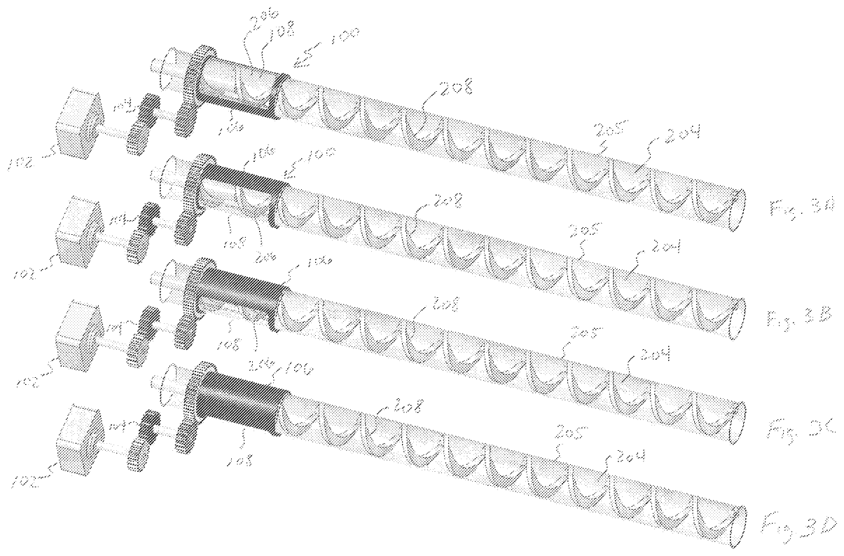

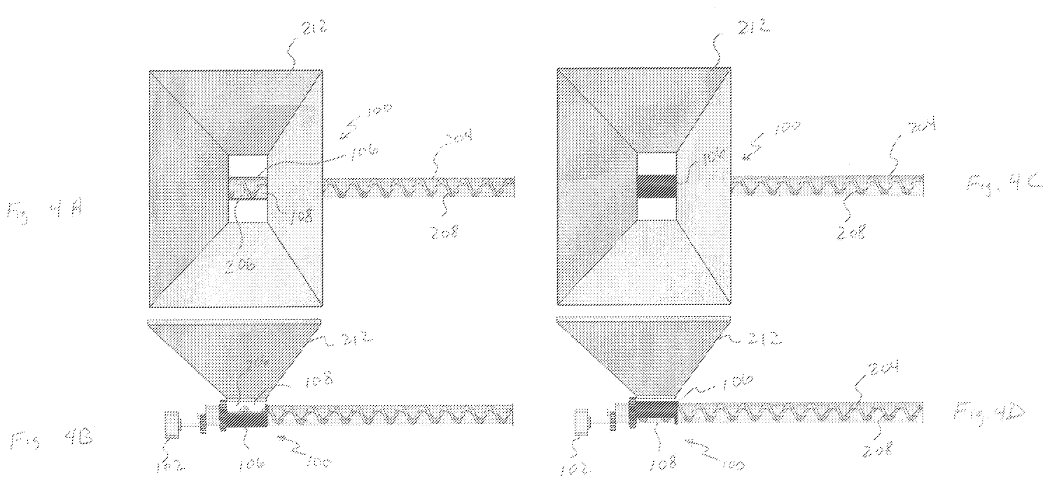

FIGS. 3A-3B and 4A-4D further illustrate how the mechanism 100 works. FIG. 3A is a perspective cutaway view of the pellet feed shutoff mechanism 100 in an open state; FIG. 3B is a perspective cutaway view of the pellet feed shutoff mechanism 100 approximately half closed; FIG. 3C is a perspective cutaway view of the pellet feed shutoff mechanism 100 nearly completely closed; and FIG. 3D is a perspective cutaway view of the pellet feed shutoff mechanism 100 of FIG. 3A completely closed. The rotary sleeve 106 has a cutout 108 that in general is the same shape and size of the entrance opening or cutout 206 of the pellet delivery channel 204 (for practicality, it can be slightly larger to allow for easier alignment). When the system is off, at standby mode, at shutdown mode, or any other scenario that does not require for the pellets to be delivered from the hopper to the firepot, the rotary sleeve 106 is positioned as such to block the entrance 206 into the delivery channel 204. When the pellet grill/smoker is operating in any cooking mode (or any other scenario that does require for the pellets to be delivered into the firepot), the sleeve 106 may be rotated 180° to align the opening at the delivery channel 204 entrance 206 and the cutout 108 in the sleeve 106. This allows for normal flow or free flow of pellets from the hopper 212 into the delivery system. Again, as the cooking is completed and the pellet grill/smoker goes through the shutdown process, the sleeve 106 may rotate another 180° (or back)180° and shut off the pellet feed.

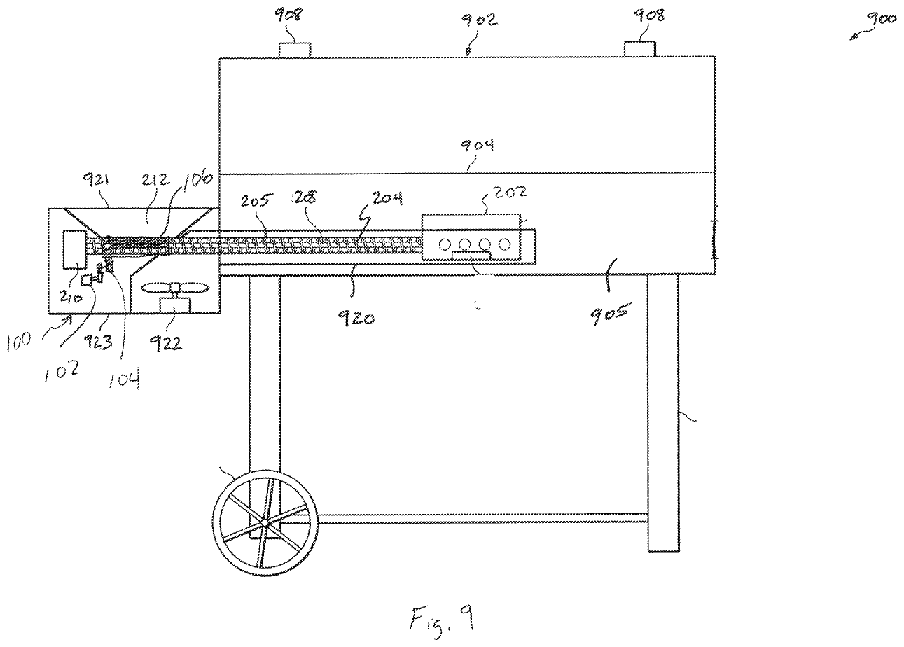

For further reference, FIG. 4A is an overhead simplified view of the pellet feed shutoff mechanism 100 in the open state. FIG. 4B is a side view of the pellet feed shutoff mechanism 100 in the open state. FIG. 4C is an overhead simplified view of the pellet feed shutoff mechanism 100 in a closed state. FIG. 4D is a side view of the pellet feed shutoff mechanism 100 in the closed state. It should be understood that the simplified views of the present disclosure are provided without all surrounding components as are otherwise known in the art (see, e.g., FIG. 9).

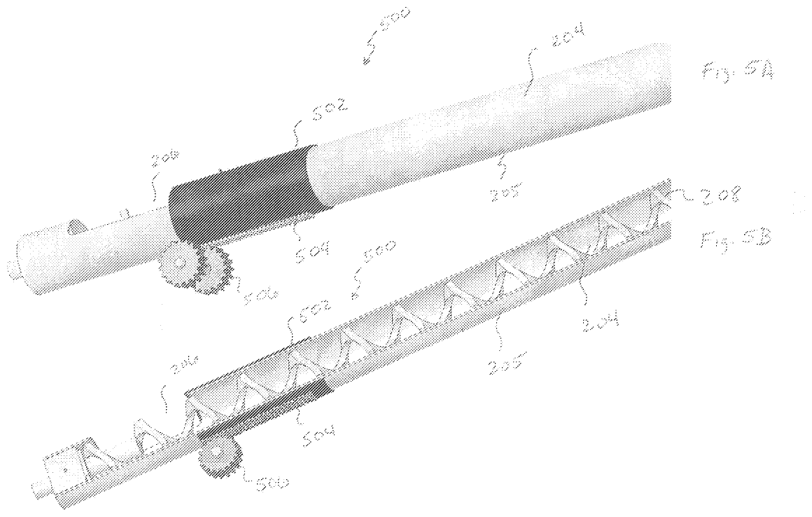

Referring now to FIG. 5A, a simplified side view of another pellet feed shutoff mechanism 500 according to the present disclosure is shown. A simplified side cutaway view of the pellet feed shutoff mechanism 500 is shown in FIG. 5B. A shut-off sleeve 502 or other door or blocking panel may be movable around or inside the delivery channel 204 at the vicinity of its entrance opening 206 defined by the auger tube 205. In the case where a rotary sleeve 106 or sliding sleeve 502 moves around the physical surface of the delivery channel 204, the geometrical profile of the rotary sleeve 106 or sliding sleeve 502 may generally follow the profile of the delivery channel 204 or auger tube 205, at least where they make contact or lie adjacent. Thus, the components can be circular, U-shaped, rectangular, or of another desired profile. In the case of a sliding door or a rotary door that does not have a coaxial relationship with the delivery channel, the conformity of the profiles may not be strictly necessary.

FIGS. 5A and 5B illustrate an open configuration where the sleeve 502 is displaced away from the opening 206 of the delivery channel 204 or auger tube 205. It can be seen that a rack 504 may be affixed to the sleeve 502 that meshes with a pinion 506 for displacement of the sleeve 502. The pinion 506 may be powered by an electric motor and/or gearing mechanism where needed (e.g., motor 102 and/or gearing mechanism 104). The pinion 506 may also be operated manually by an external knob, for example.

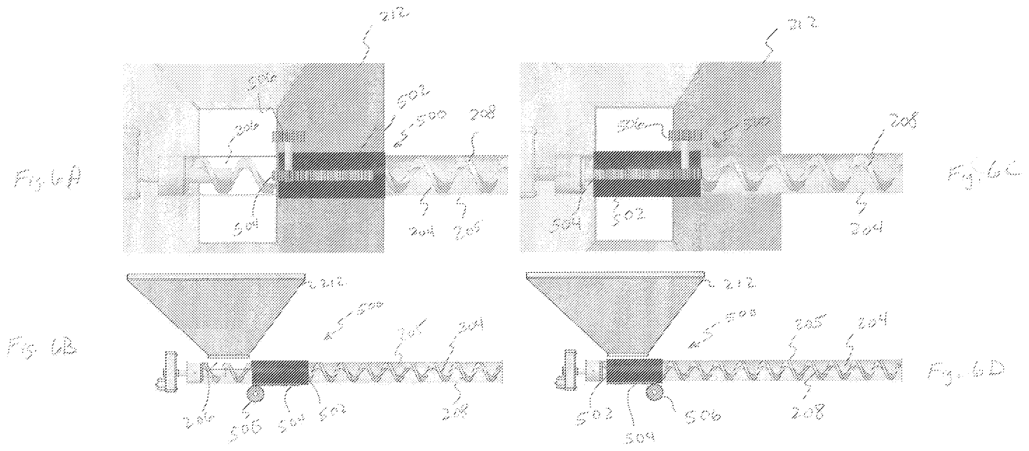

Referring now to FIG. 6A, a simplified inferior view of the pellet feed shutoff mechanism 500 in the context of a hopper and pellet delivery system is shown. FIG. 6B is a side view of the pellet feed shutoff mechanism 600 of FIG. 6A. FIGS. 6A-6B illustrate an open position wherein the hopper 212 feeds pellets into the opening 206. For clarity the auger tube 205 is ghosted. In some embodiments, the shape of the hopper 212 is such that a bottom opening of the hopper 212 is approximately sized to match the opening 206 of the delivery channel 204. The hopper 212 may feature side walls that taper to the opening 206 and/or the hopper 212 may provide a floor (not shown) with an opening of the same size, or approximately the same size, as the opening 206 of the delivery channel 204. FIG. 6C is an inferior view of the pellet feed shutoff 600 mechanism of FIG. 6A in a closed position, while FIG. 6D is a side view of the pellet feed shutoff mechanism 600 in the closed position.

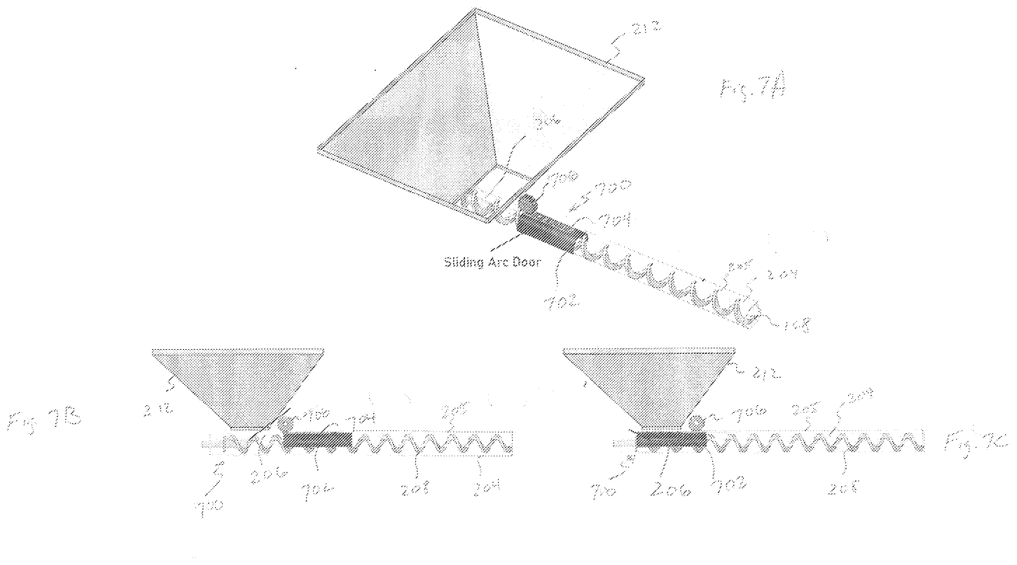

Referring now to FIG. 7A is a simplified perspective view of another pellet feed shutoff mechanism 700 of the present disclosure in the context of a hopper and pellet delivery system is shown. FIG. 7B is a side view of the pellet feed shutoff mechanism 700 of FIG. 7A. FIGS. 7A-7B illustrate an opening position, while FIG. 7C is a side view of the pellet feed shutoff mechanism 700 in a closed position. FIG. 7D is a side view of the pellet feed shutoff mechanism 700 in the closed position. The auger tube 205 is ghosted for clarity. Additionally, in these views, some components known in the prior art are omitted.

The system 700 is somewhat similar to the system 600. However, the system 600 utilizes a sleeve 502 surrounding the auger tube 204 while the system 700 utilizes an arcuate panel 702 or other door or blocking panel that only covers an upper portion of the auger tube 205 corresponding to the side with the opening 206. The pinion 506 of the system 600 operates on a lower side of the shut off sleeve 502, while the pinion 706 of the system 700 operates on a rack 704 situated superior to the auger tube 205 and delivery channel 204. The system 700 may allow for less material to be used and a lighter final product, and may allow for a more compact system over all since the rack 704 and pinion 706 can operate in a area under the hopper 212 that may not otherwise be utilized.

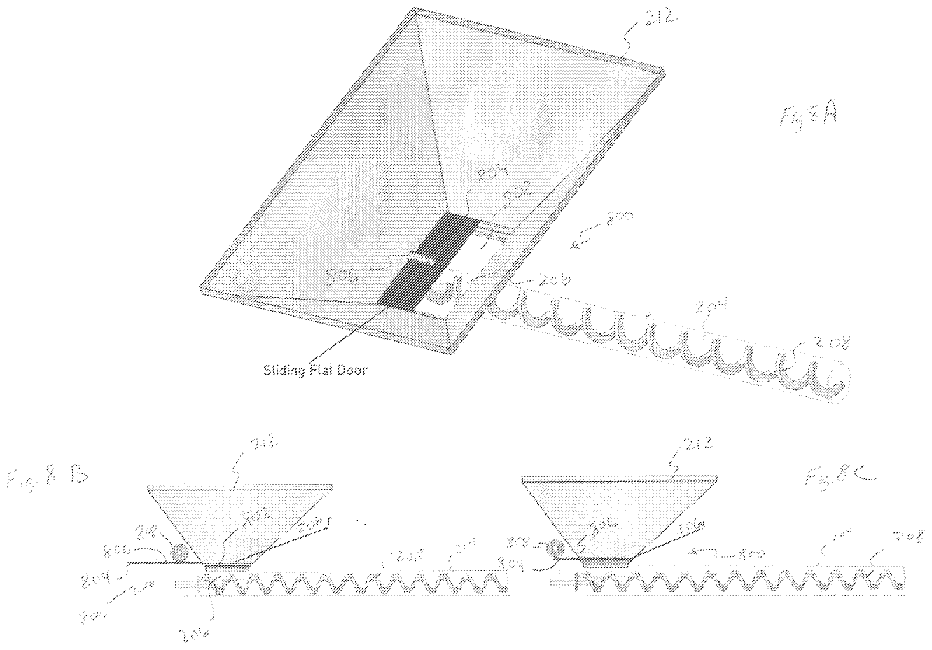

Referring now to FIG. 8A a simplified perspective view of another pellet feed shutoff mechanism 800 of the present disclosure in the context of a hopper and pellet delivery system is shown. FIG. 8B is a side view of the pellet feed shutoff mechanism 800 in an open position while FIG. 8C is a side view of the pellet feed shutoff mechanism 800 in a closed position. A shut-off gate 804 or other blocking panel may comprise a sliding door (flat or curved or other geometry) that opens and closes the entrance 206 into the pellet delivery channel 204 by selective closing a bottom 802 or floor of the hopper 212. The gate 804 may be opened or closed manually. In the illustrated embodiment, a rack 806 is affixed to the gate 804 that meshes with a pinion 808 for movement of the gate 804. The pinion 808 may be rotated by a motor and/or gear train or by manual rotation of a remote handle, for example.

In another embodiment, door or gate 804 can be a one-piece or two-piece rotary flap that open or close the exit 802 of the pellet hopper 212. The axis (or axes) of rotation can be horizontal, vertical, or diagonal. Such mechanism can operate either manually or via a motor.

In another embodiment, the pellet movement may be selectively blocked by relative movement of the entrance 206 of the delivery channel 204 with respect to the exit 802 of the hopper 212. This may be achieved by linear movement of the delivery channel 204 to fully offset its 206 entrance from the exit 802 of the hopper 212. Selective blocking may also be achieved via rotational (such as axial) movement of the delivery channel 204 (such that the opening 206 is facing downward). Alternatively, the delivery channel 204 can be fixed in space and the pellet hopper 212 moved relative thereto. In any of these configurations, passage of the pellets from hopper 212 into the delivery channel 204 opens as the user starts grilling/smoking and it closes as the unit is turned to the shutdown mode. Each of these mechanisms can be driven by electro-mechanical devices such a motor that is controlled by the main control system or can be operated manually.

In such a configuration that the pellet feeder shut-off mechanism (e.g., 100/500/700/800) is driven electromechanically by a motor , it is possible to use standalone motor dedicated to the shut-off system; also, it is possible to share a motor to drive both the pellet transporter device (e.g., auger 208 or a conveyer belt) and the shut-off system by using a clutch system. In both cases of using manual or electro-mechanical means of positioning the shut-off system, it is possible to use magnetic or mechanical locators/stoppers to precisely position the sleeve or door at desired open/closed positions.

Pellet feed shut-off mechanisms according to various embodiments of the present disclosure offers some unique benefits that may be applied to any pellet grill/smoker regardless of the means used for transporting the pellet fuel from the hopper into the firepot. For example, FIG. 9 is a frontal cutaway view of a pellet grill 900 having a pellet feed shutoff mechanism according to the present disclosure. The grill 900 may comprise a cooking chamber 902 having a cooking grate 904 for supporting food items such as meat for grilling or smoking. Exhaust openings 908 may be provided for escape of smoke and other gaseous cooking products. It should be understood that a grill may have various other doors, access panels, adjustable vents, and other components known to the art.

A firebox 905 below, or integral with, the cooking chamber 902 may contain a heat source such as firepot 202. The delivery channel 204 defined by the auger tube 205 or other structure may enter the firebox 905 from a cabinet 923 where the hopper 212 may be located. The cabinet 923 may provide a lid 921 for access to the hopper 212. As described, as pellets flow through the hopper to the delivery channel 204, they may be selectively interrupted or cutoff via one of the shut-off systems described herein. For purposes of illustration, the shutoff system 100 is shown as a part of the grill 900 but it should be understood that any embodiment of a pellet shut off system according to the present disclosure may be fitted to the grill 900 or other grills as are known in the art.

The rotary sleeve 106 is illustrated as positioned to block pellet flow from the hopper into the delivery channel 204. It may be rotated to the open position by the motor 102 as described above. The auger tube 205 and/or delivery channel 204 may traverse through the cabinet 923 and the firebox 905 within an air plenum 920 as are known in the art for supplying combustion air to pellet fueled firepots such as firepot 202. A fan 922 may force external air into the plenum 920 as known in the art.

Use of one of the pellet cutoff systems of the present disclosure to allow the delivery channel 204 to be empty means it will not be jammed by exposure to environment moisture when containing no pellets, or substantially no pellets. The delivery channel 204 may be, but is not limited to, a tube or a U-channel defined by the auger tube 205 or other component through which pelletized fuel is delivered from a hopper or other reservoir to a location where it is utilized as fuel for smoking, grilling, or other cooking operations. The transporter can be, but is not limited to, the auger 208, a conveyer belt, or other motive device. Similarly, a grill or smoker with which pellet feed shutoff mechanisms of the present disclosure may be deployed can vary widely and may differ from that show in FIG. 9.

It should be understood that selectively openable or closeable means that the components are capable of being positioned such that pellet flow is opened, or that it is closed.

Such movement is based, without limitation, on selection of the user or of a pellet grill control system.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system comprising:
a pellet fuel delivery channel spanning between a pellet fuel hopper and a firepot; and
a door selectively blocking fuel pellets from leaving the hopper and entering the fuel delivery channel.

2. The system of claim 1, wherein the fuel delivery channel is defined by an auger tube and the door comprises a sleeve defining a cutout that is rotatable about the auger tube to selectively cover an opening defined in the tube.

3. The system of claim 3, wherein the sleeve is rotatable about the auger tube by an electric motor.

4. The system of claim 1, wherein the fuel delivery channel is defined by an auger tube having an opening into the delivery channel, and the door slides axially along the auger tube to open and close the opening into the delivery channel.

5. The system of claim 4, wherein the door comprises a sleeve surrounding the auger tube.

6. The system of claim 5, wherein the door is moved axially along the auger tube via an electric motor engaging with a pinion and a rack on a lower side of the sleeve.

7. The system of claim 4, wherein the door comprises an arcuate member atop the auger tube.

8. The system of claim 7, wherein the arcuate member is moved axially along the auger tube by an electric motor engaged with a pinion and a rack on the arcuate member.

9. The system of claim 4, wherein the door comprises a flat panel opening and closing a lower opening of the hopper.

10. The system of claim 9, wherein the flat panel is moved to open and close the hopper by an electric motor engaged with a pinion and a rack on the flat panel.

11. A system comprising:
a cooking chamber having a cooking grate;
a firepot utilizing pelletized fuel to heat the cooking chamber;
a cabinet outside the cooking chamber having a hopper for receiving the pelletized fuel;
a delivery channel moving pelletized fuel from the hopper to the firepot; and
a pellet fuel shutoff door selectively blocking pelletized fuel from entering into the delivery channel from the fuel hopper.

12. The system of claim 12, wherein the delivery channel is defined by an auger tube having an opening that receives pelletized fuel from the fuel hopper when the shutoff door is in an open position.

13. The system of claim 12, wherein the pellet fuel cutoff door further comprises a sleeve coaxial with the auger tube and defining a cutout, the sleeve being rotatable such that the cutout aligns with the opening in the auger tube to admit pelletized fuel from the hopper, and being further rotatable such that the cutout does not align with the opening in the auger tube and pelletized fuel from the hopper is blocked.

14. The system of claim 12, wherein the pellet fuel cutoff door further comprising an arcuate member fitted to the auger tube and slidable axially along the tube to selectively cover the opening in the auger tube.

15. The system of claim 12, wherein the pellet fuel shutoff door comprises a flat panel below the hopper.

16. The system of claim 12, wherein the shutoff door has a pinion affixed thereto, the shutoff door being moved between a closed position and the open position by a pinion meshed with the rack and driven by an electric motor.

17. A method comprising:
providing a firepot that burns pelletized fuel in a cooking chamber for cooking food on a cooking grate within the cooking chamber;
providing a fuel hopper outside the cooking chamber;
providing a fuel delivery channel between the fuel hopper and the cooking chamber; and
providing a door that selectively blocks fuel from the hopper from entering the fuel delivery channel.

18. The method of claim 17, wherein:
providing a fuel delivery channel further comprising placing an auger tube between the fuel hopper and the firepot; and
providing a door further comprises placing a sleeve on the auger tube that may be moved to cover an opening defined in the tube.

19. The method of claim 17, wherein:
providing a fuel delivery channel further comprising placing an auger tube between the fuel hopper and the firepot; and
providing a door further comprises placing a sleeve on the auger tube that has a cutout that may be moved to align or misalign with an opening defined in the tube.

20. The method of claim 17, further comprising providing an electric motor configured to move the door between open and closed positions to selectively block fuel from the hopper from entering the fuel delivery channel.
